(19) United States
(12) Patent Application Publication
(10) Pub. No.: US 2019/0202232 A1
(43) Pub. Date: Jul. 4, 2019

(54) PREFABRICATED CANVAS FRAME

(71) Applicant: Sang Ho Lee, Gyeonggi-do (KR)

(72) Inventor: Sang Ho Lee, Gyeonggi-do (KR)

(21) Appl. No.: 15/859,810

(22) Filed: Jan. 2, 2018

(51) Int. Cl. B44D 3/18; A47G 1/06; A47G 1/10

(52) U.S. Cl. CPC B44D 3/185; A47G 1/10; A47G 1/0605

(57) ABSTRACT

The present invention relates to a prefabricated canvas frame for fitting canvas to display the canvas, including: a square prefabricated frame adapted to detachably fit the canvas thereto; and a stripe member disposed on the prefabricated frame to support the canvas thereagainst, wherein the prefabricated frame includes corner members and edge members fitted to each other and the stripe member includes corner stripes located along the corner members and edge stripes located along the edge members, each edge stripe having a higher height by a wall surface thickness of each corner member than each corner stripe so that when the edge member is fitted to the corner member, top of the edge stripe and top of the corner stripe of the corner member are arranged on the same line as each other.

### BACKGROUND OF THE INVENTION

### Field of the Invention

The present invention relates to a prefabricated canvas frame, and more particularly, to a prefabricated canvas frame that is provided with a prefabricated frame having corner members and edge members fitted to each other.

### Background of the Related Art

Canvas is a fabric that is fixed to a generally square wooden frame and has a painting surface on which a picture is drawn with oil colors, and the frame is used to hang drawing paper like picture or painting fitted thereto on a wall so as to display the drawing paper.

A square frame is made of wood or extrusion moldable synthetic resin. So as to make the square frame, a bar-shaped edge member having various side sections and a small width is first made to a given length, and an appropriate ratio of a horizontal edge to a vertical edge of the frame is selected according to the size of the frame to be made, so that the edge member is cut to four edge members and the cut edge members are fitted to each other to provide the square frame.

When the cut edge members corresponding to the respective sides are fitted to each other to the form of the square frame, by the way, it is not easy to perform corner machining. In more detail, facing surfaces of the edge members on the respective sides at a point where the horizontal and vertical sides meet each other are subjected to V cutting (cutting to an angle of 45°) so that both sides face each other at a right angle. However, the V cutting is hard machining requiring a high degree of precision. Accordingly, ready-made products manufactured in large quantities by production companies are widely used as the frames. In this case, the ready-made products are pre-selected in sizes and supplied, thereby undesirably causing many inconveniences in use of various drawing paper.

### SUMMARY OF THE INVENTION

Accordingly, the present invention has been made in view of the above-mentioned problems occurring in the prior art, and it is an object of the present invention to provide a prefabricated canvas frame that is provided with a prefabricated frame having corner members and edge members fitted to each other.

To accomplish the above-mentioned object, according to a first aspect of the present invention, there is provided a prefabricated canvas frame for fitting canvas to display the canvas, including: a square prefabricated frame adapted to detachably fit the canvas thereto; and a stripe member disposed on the prefabricated frame to support the canvas thereagainst, wherein the prefabricated frame includes corner members located at four corner portions of the canvas and edge members for connecting the corner members to allow the prefabricated frame to have the shape of square, the corner members and the edge members having a shape of a hollow tube, and the stripe member includes corner stripes located along the corner members and edge stripes located along the edge members, each corner stripe being formed unitarily with each corner member and each edge stripe being formed unitarily with each edge member, each edge stripe having a higher height by a wall surface thickness of each corner member than each corner stripe so that when the edge member is fitted to the corner member, top of the edge stripe and top of the corner stripe of the corner member are arranged on the same line as each other.

To accomplish the above-mentioned object, according to a second aspect of the present invention, there is provided a prefabricated canvas frame for fitting canvas to display the canvas, including: a square prefabricated frame adapted to detachably fit the canvas thereto; and a stripe member disposed on the prefabricated frame to support the canvas thereagainst, wherein the prefabricated frame includes corner members located at four corner portions of the canvas and edge members for connecting the corner members to allow the prefabricated frame to have the shape of square, the corner members and the edge members having a shape of a hollow tube, and the stripe member includes corner stripes located along the corner members and edge stripes located along the edge members, each corner stripe being formed unitarily with each corner member and each edge stripe being formed unitarily with each edge member, and each corner member having a corner open portion open from an inner side thereof to a corner thereof so that when the edge member is inserted into the inside of the corner member, the edge stripe is exposed to the outside through the corner open portion.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a front view showing a prefabricated canvas frame according to a first embodiment of the present invention;

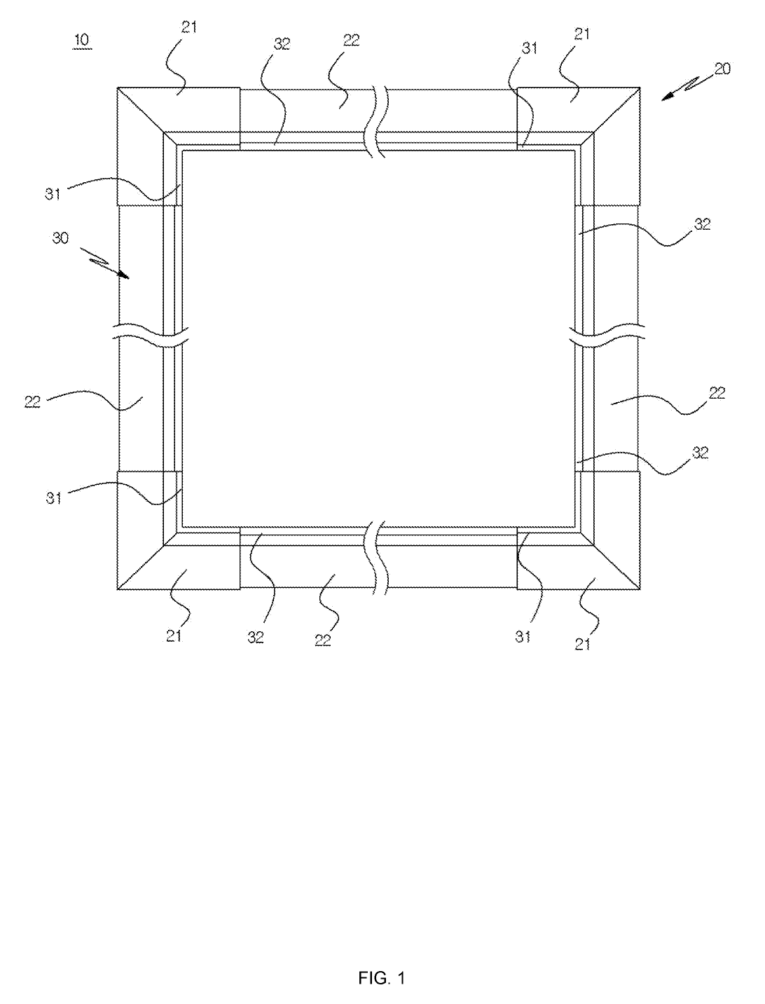

FIG. 2 is a perspective view showing one of corner members of the prefabricated canvas frame according to the first embodiment of the present invention;

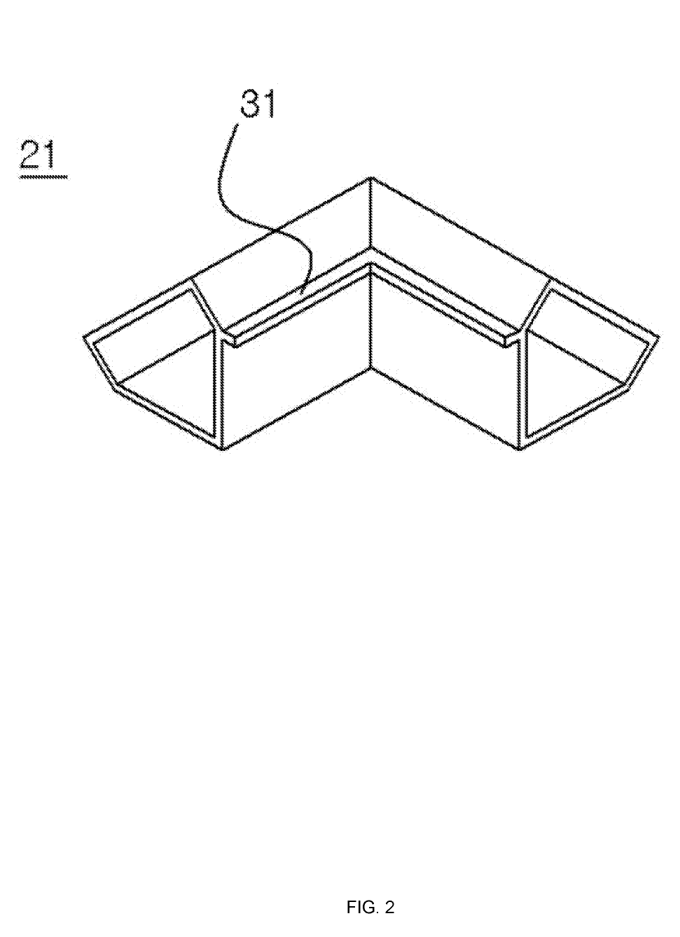

FIG. 3 is a perspective view showing one of edge members of the prefabricated canvas frame according to the first embodiment of the present invention;

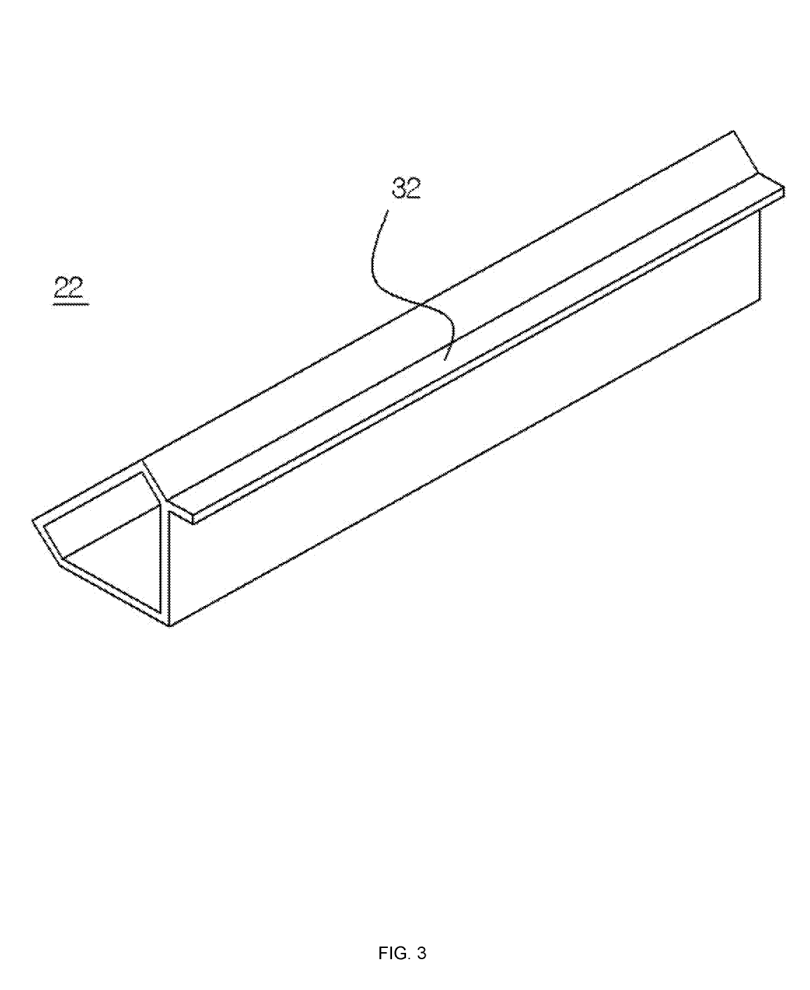

FIG. 4 is a perspective view showing a process of cutting a portion of an edge stripe in the prefabricated canvas frame according to the first embodiment of the present invention;

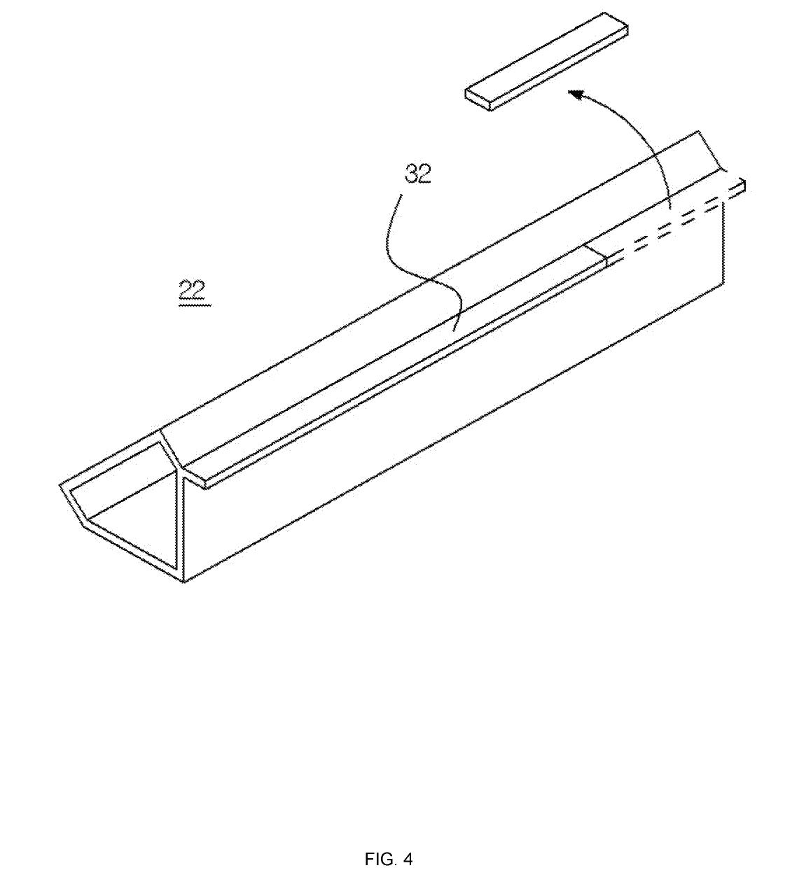

FIG. 5 is a perspective view showing a process of fastening a stripe member to the corner member and the edge member in the prefabricated canvas frame according to the first embodiment of the present invention;

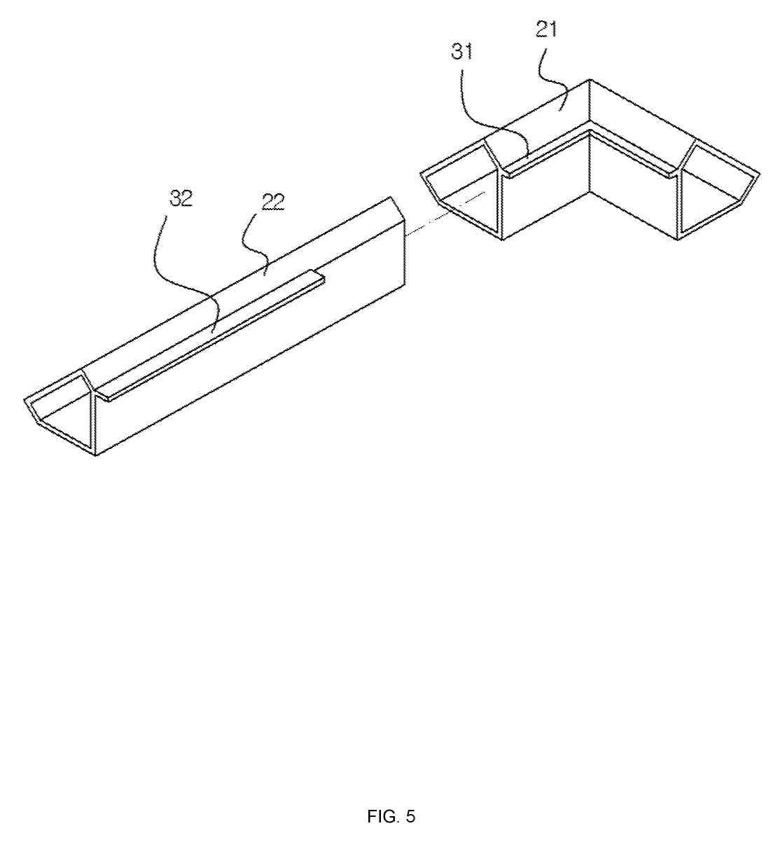

FIG. 6 is a perspective view showing a state where the corner member and the edge member are fastened to each other in the prefabricated canvas frame according to the first embodiment of the present invention;

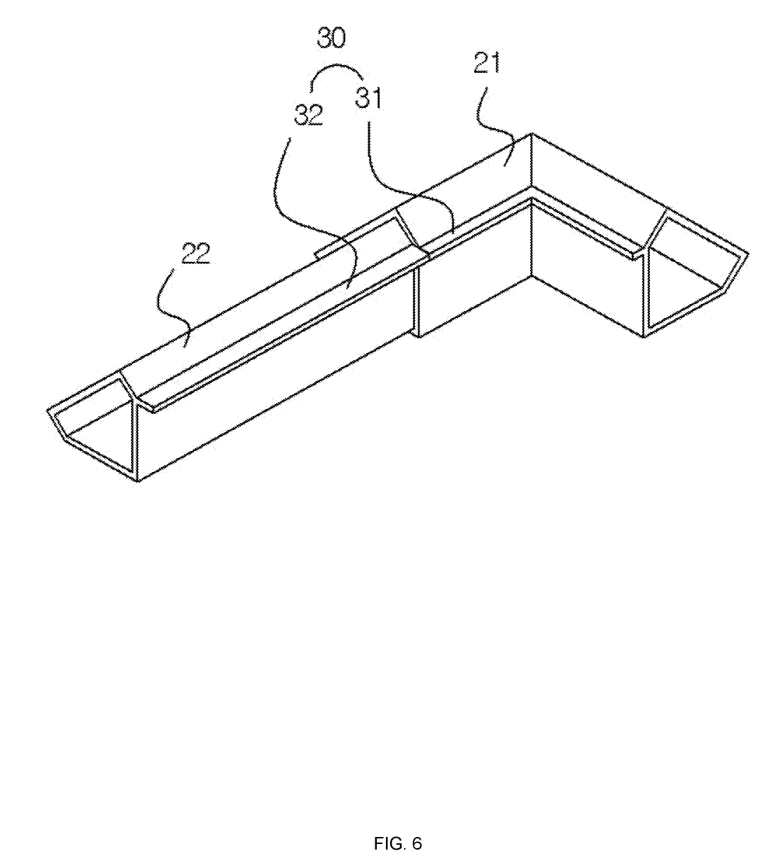

FIG. 7 is a partial front view showing heights of the edge stripe and the corner stripe of the prefabricated canvas frame according to the first embodiment of the present invention;

FIG. 8 is a front view showing a state where canvas is fastened to the prefabricated canvas frame according to the first embodiment of the present invention;

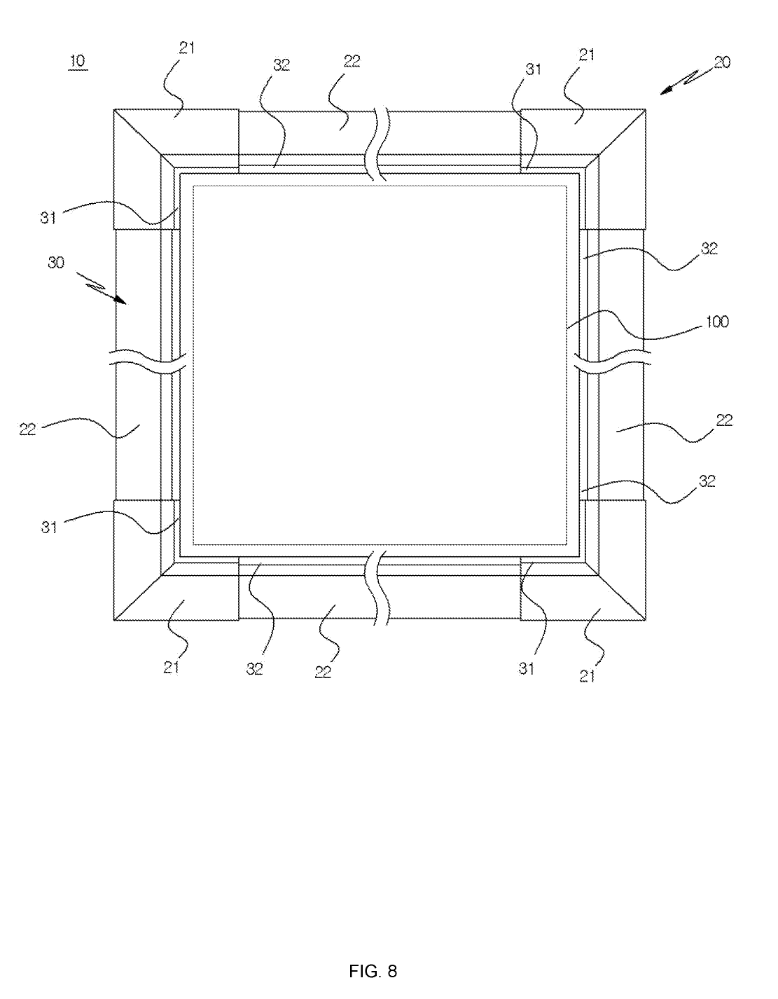

FIG. 9 is a front view showing another example of the edge member in the prefabricated canvas frame according to the first embodiment of the present invention;

FIG. 10 is a perspective view showing a prefabricated canvas frame according to a second embodiment of the present invention;

FIG. 11 is a perspective view showing a process of fastening an edge member to a corner member in the prefabricated canvas frame according to the second embodiment of the present invention;

FIG. 12 is a perspective view showing a state where the corner member and the edge member are fastened to each other in the prefabricated canvas frame according to the second embodiment of the present invention; and

FIG. 13 is a sectional view showing the state where the corner member and the edge member are fastened to each other in the prefabricated canvas frame according to the second embodiment of the present invention.

### DETAILED DESCRIPTION OF THE PREFERRED EMBODIMENTS

Now, an explanation on a prefabricated canvas frame according to the present invention will be given with reference to the attached drawings.

A prefabricated canvas frame 10 according to the present invention is a frame to which canvas is fitted, and the canvas is a fabric that is used as a painting surface and is stretched across a generally square frame made of wood or synthetic resin and covered with a cloth on one surface thereof. Typically, the canvas frame is mounted on a wall and displayed.

The prefabricated canvas frame 10 according to a first embodiment of the present invention is a frame to which canvas is fitted and includes a square prefabricated frame 20 to which the canvas is detachably fitted and a stripe member 30 disposed on the prefabricated frame 20 to support the canvas thereagainst, wherein the prefabricated frame 20 includes corner members 21 of angle structures located at four corner portions of the canvas and edge members 22 for connecting the corner members 21 to allow the prefabricated frame 20 to have the shape of square. Accordingly, four corner members 21 are located and four edge members 22 are fastenedly connected to the corner members 21.

The corner members 21 and the edge members 22 have a shape of a hollow tube.

As the corner members 21 and the edge members 22 have the shape of the hollow tube, they are more lightweight than a structure having filled interiors, so that an amount of material consumed is reduced, the prefabricated canvas frame 10 does not fall down from a fixed wall surface by means of a self weight thereof, and cutting and coupling are easy, without any separate tool.

The corner members 21 and the edge members 22 have protruding portions formed outwardly therefrom to a triangular sectional shape, thereby making a user feel an aesthetic sense.

The corner members 21 and the edge members 22 are made of paper materials, and of course, they may be made of synthetic resin or metal materials.

Each corner member 21 has locking grooves formed along inner side surfaces thereof, and each edge member 22 has fastening grooves formed on the outer surfaces of end portions thereof, so that after a portion of an elastic ring is fitted to each fastening groove of the edge member 22, a protruding portion of the elastic ring is fitted to each locking groove of the corner member 21, thereby allowing the corner member 21 and the edge member 22 to be fixed to each other by means of the elastic force of the elastic ring.

The prefabricated frame 20 desirably has a loop mounted thereon to allow the prefabricated canvas frame 10 according to the present invention to be hung on a wall surface.

The edge members 22 of the prefabricated frame 20 are cut according to sizes of canvas so as to allow the size of the prefabricated frame 20 to correspond to the size of canvas, and next, the canvas is fixedly fitted to the prefabricated frame 20.

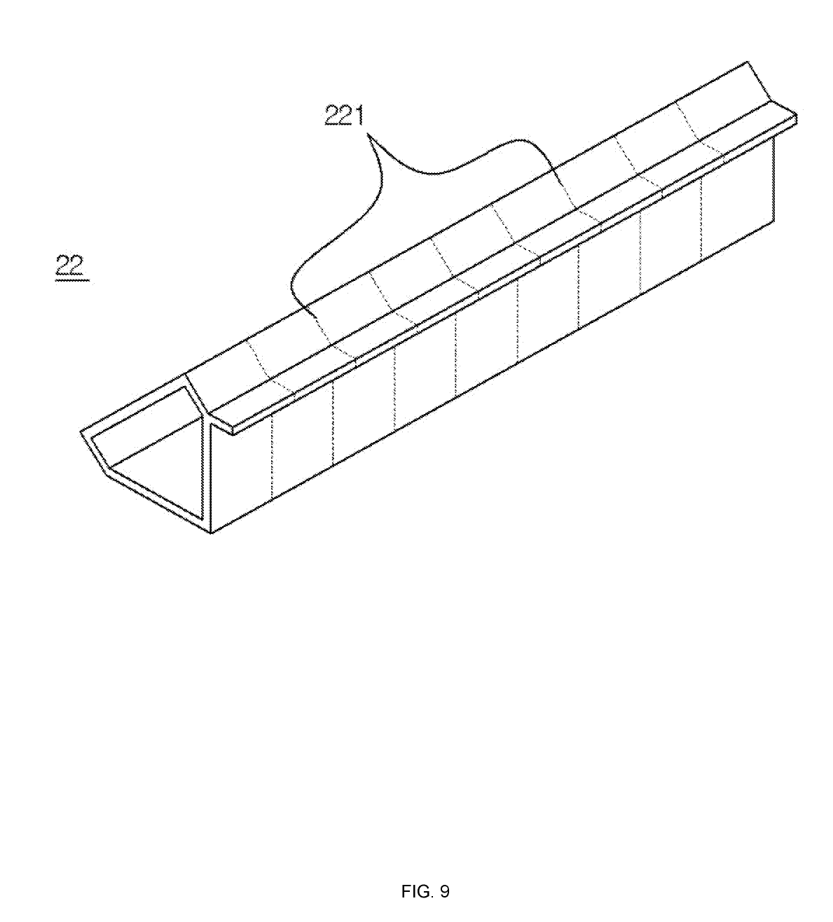

As shown in FIG. 9, on the other hand, the edge member 22 has a plurality of cut-off lines spaced apart from each other by a given distance, so that if it is desired to reduce the length of the edge member 22, the edge member 22 may be cut easily along a user's desired cut-off line. Also, the edge member 22 desirably has graduations inclusive of sizes indicated on one surface thereof in a longitudinal direction thereof, thereby accurately cutting the edge member 22 according to the sizes of canvas.

The stripe member 30 is located on the prefabricated frame 20 to support the canvas fitted to the prefabricated frame 20 thereagainst and includes corner stripes 31 located along the corner members 21 and edge stripes 31 located along the edge members 22.

The prefabricated frame 20 is made by fitting the edge members 22 to the corner members 21 and then by fixedly bonding the corner stripes 31 of the corner members 21 and the edge stripes 32 of the edge members 22 to each other.

The corner stripes 31 and the edge stripes 32 are fixedly bonded to each other by means of an adhesive, and of course, they may be fixedly bonded to each other by means of tapes.

The stripe member 30 supports the front surface of the canvas fitted to the prefabricated frame 20 to prevent the canvas from being deviated from the prefabricated frame 20 to the outside, and the underside of the canvas is supported against the wall surface on which the prefabricated canvas frame 10 is located to prevent the canvas from escaping from the prefabricated frame 20. Of course, desirably, the prefabricated frame 20 has rotatable hooks disposed on the underside thereof to suppress the canvas fitted thereto from being isolated therefrom.

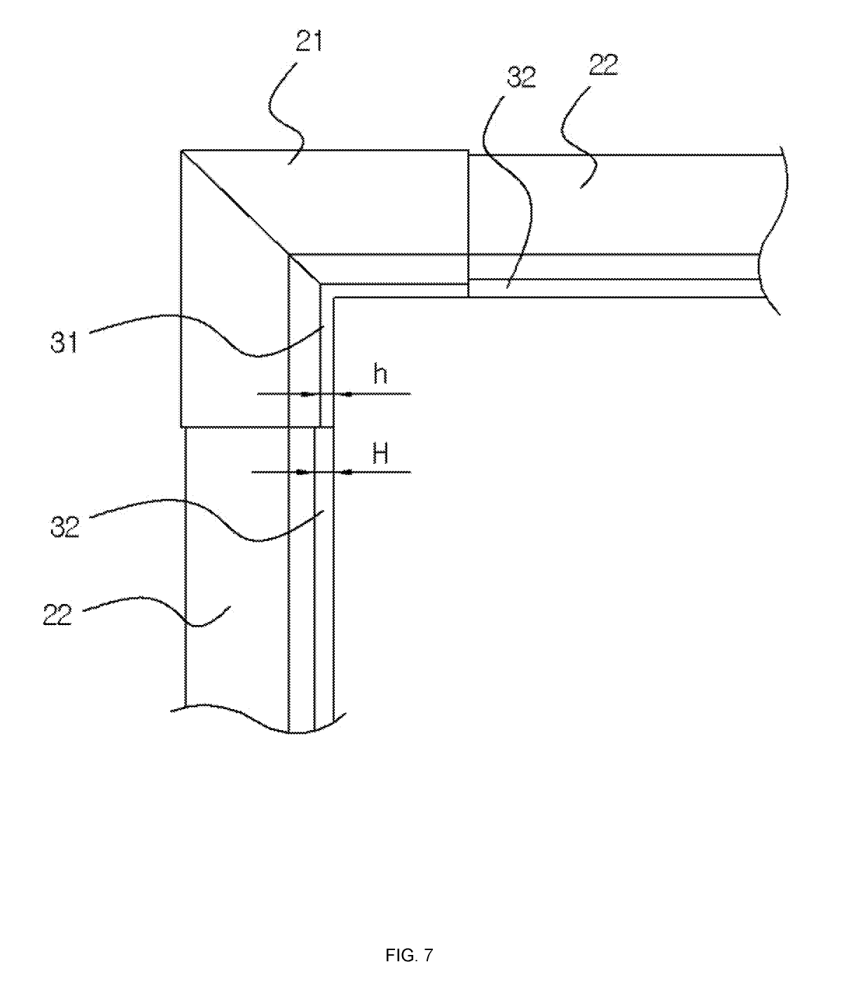

As shown in FIG. 7, a height H of each edge stripe 32 is higher by a wall surface thickness of each corner member 21 than a height h of each corner stripe 31, and when the edge member 22 is fitted to the corner member 21, accordingly, top of the edge stripe 32 and top of the corner stripe 31 of the corner member 21 are arranged on the same line as each other. If the stripe member 30 is stepped, the prefabricated canvas frame 10 may fall down when locked onto a user's clothes or other items. According to the present invention, however, the above-mentioned problems are completely solved, and further, the prefabricated canvas frame 10 having a sophisticated outer appearance is provided.

The corner stripe 31 is formed unitarily with the corner member 21, and the edge stripe 32 is with the edge member 22. Through attaching or fusing, otherwise, the corner stripe 31 is fixed to the corner member 21 and the edge stripe 32 is to the edge member 22.

Through the formation of the stripe member 30, further, the strengths of the corner members 21 and the edge members 22 are enhanced, and their bending is prevented.

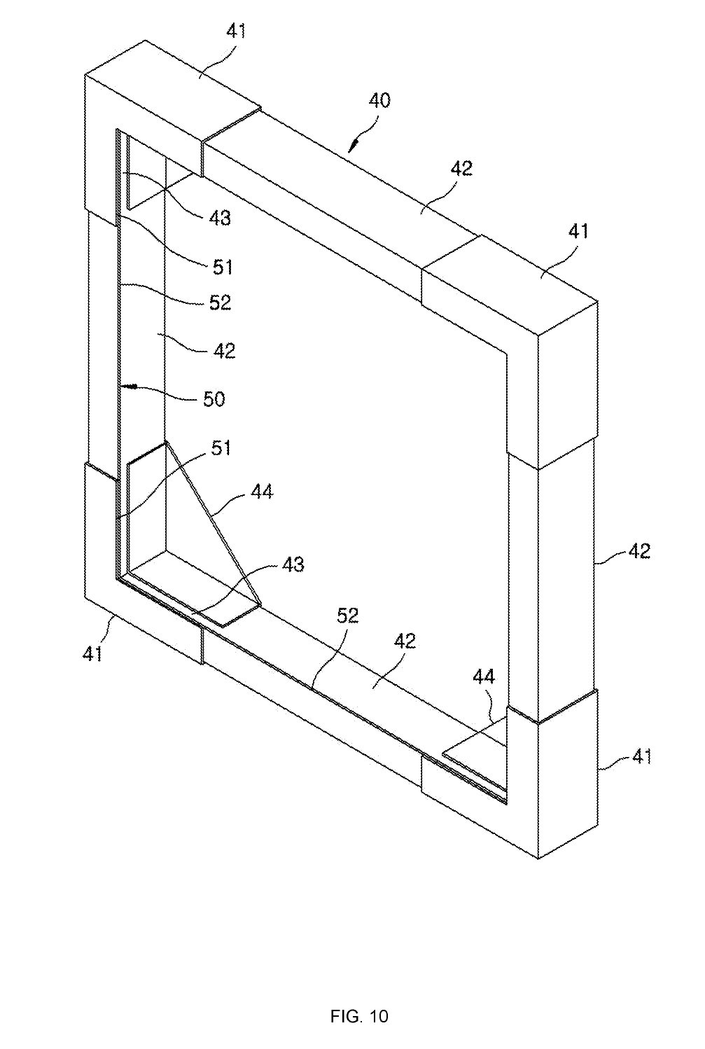

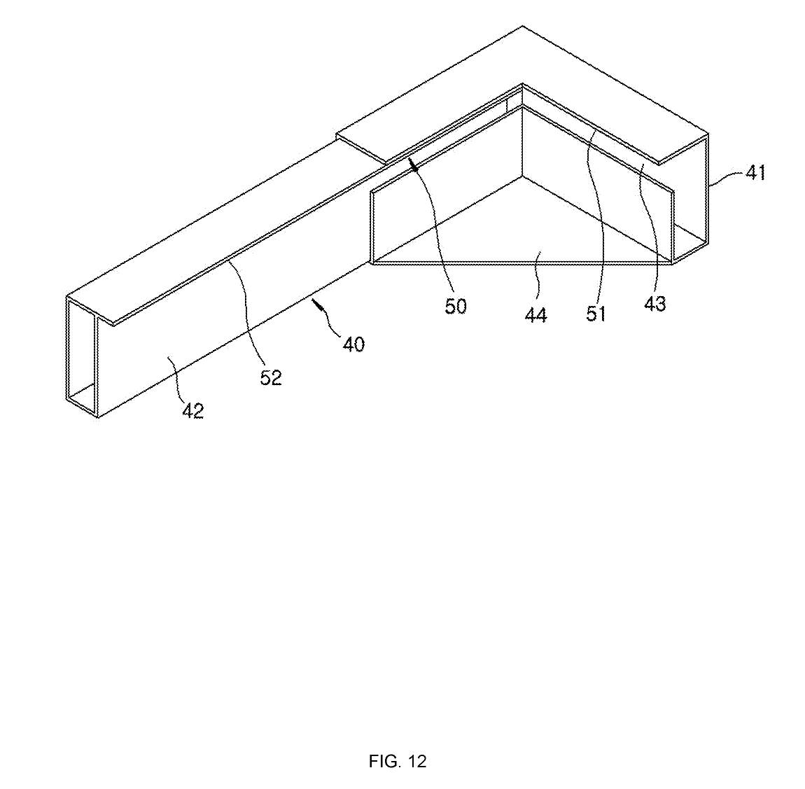

FIGS. 10 to 12 show a prefabricated canvas frame according to a second embodiment of the present invention.

As shown in FIGS. 10 to 12, a prefabricated canvas frame according to a second embodiment of the present invention is a frame to which canvas is fitted and displayed and includes a square prefabricated frame 40 to which the canvas is detachably fitted and a stripe member 50 disposed on the prefabricated frame 40 to support the canvas thereagainst, wherein the prefabricated frame 40 includes corner members 41 located at four corner portions of the canvas and edge members 42 for connecting the corner members 21 to allow the prefabricated frame 40 to have the shape of square, the corner members 41 and the edge members 42 having a shape of a hollow tube, and the stripe member 50 includes corner stripes 51 located along the corner members 41 and edge stripes 52 located along the edge members 42, each corner stripe 51 being formed unitarily with each corner member 41 and each edge stripe 52 being formed unitarily with each edge member 42.

Each edge stripe 52 is extended outwardly from the edge of the edge member 42 to have the same plane as a side surface adjacent thereto. Through the simple outer appearance of the prefabricated canvas frame, accordingly, a degree of concentration on the canvas can be enhanced to permit the canvas as an artwork to stand out. The side surface adjacent to the edge member 42 is a side surface corresponding to a short side, and the edge member 42 and the corner member 41 have a cross section of a rectangular parallelepiped, so that as they are made of the hollow rectangular parallelepiped, they can be fitted to each other. Through such structures of the edge member 42 and the corner member 41, accordingly, the widths of the edges extended outwardly from the prefabricated frame 40 are reduced, while the strength of the prefabricated frame 40 is being advantageously increased.

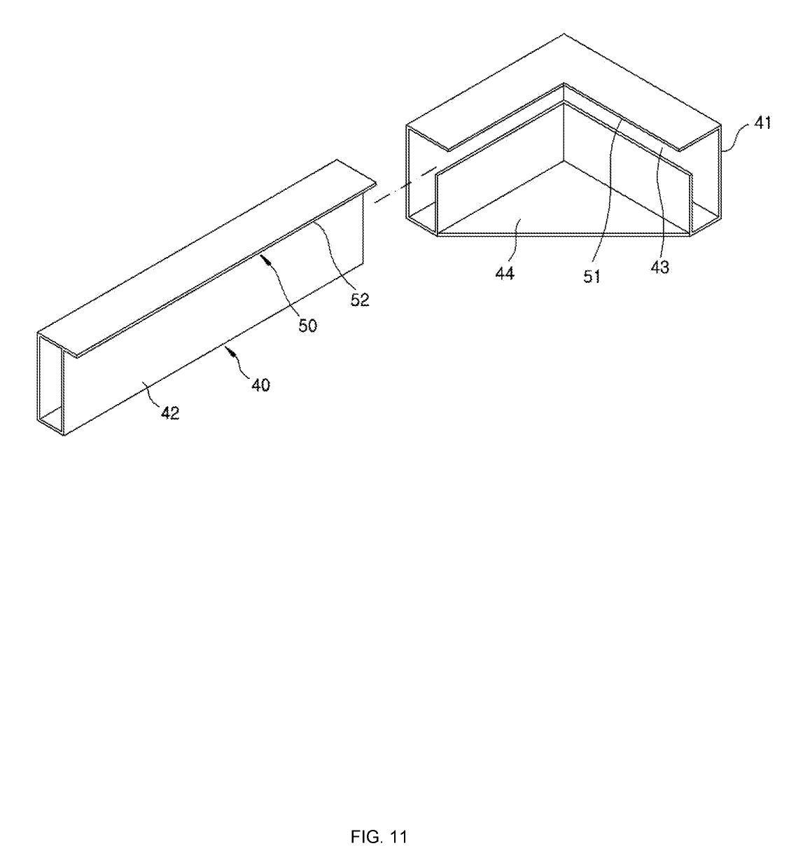

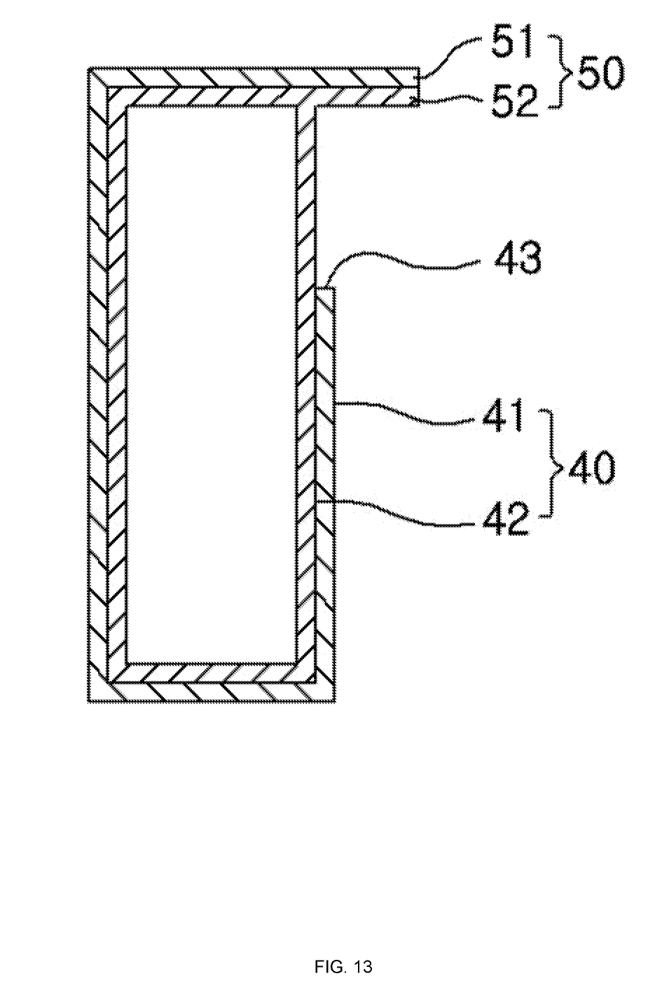

As shown in FIGS. 11 to 13, the corner member 41 has a corner open portion 43 open from an inner side thereof to a corner thereof, and when the edge member 42 is inserted into the inside of the corner member 41, the edge stripe 52 is exposed to the outside through the corner open portion 43. Accordingly, when the edge member 42 is insertedly coupled to the hollow interior of the corner member 41, the edge stripe 52 is exposed to the outside through the corner open portion 43 to avoid interference with the corner member 41, so that the corner member 41 and the edge member 42 can be simply coupled to each other by means of fitting, without any separate need to cut the edge stripe 52, and further, damages on a user's hand during cutting work may be prevented to achieve safe coupling.

Each corner stripe 51 is extended outwardly from the end portion of the edge of the corner open portion 43 to have the same plane as a side surface adjacent thereto and is laminated on the edge stripe 52 exposed to the outside through the corner open portion 43. Accordingly, a portion where the corner stripe 51 is laminated on the edge stripe 52 is formed, without any interference with the corner stripe 51, and also, reinforcement effects are obtained through the lamination, thereby making it possible to perform rigid coupling, to reduce coupling tolerances, and to enhance coupling quality.

Further, the corner member 41 includes a corner reinforcement member 44 having a plane section of a right triangle in such a manner as to connect both side surfaces perpendicular to each other toward the inside thereof. Accordingly, the formation of the corner reinforcement member 44 prevents the corner member 41 from being twisted or deformed by means of an external force, thereby providing high durability.

As described above, the prefabricated canvas frame according to the present invention includes the prefabricated frame, to which the canvas is detachably fitted, having the corner members and the edge members fitted to each other, and the corner stripes located along the corner members and the edge stripes located along the edge members to support the canvas fitted to the prefabricated frame, and as the corner members and the edge members have the shape of the hollow tube, further, they are lightweight, conveniently kept and movable, and easily cut and coupled, without any separate tool.

In addition, the prefabricated canvas frame according to the present invention is configured to simply couple the corner members and the edge members to each other by means of fitting, without any separate need to cut the edge stripes, to prevent a user's hand during cutting work from being damaged to achieve safe coupling, and to perform rigid coupling and coupling tolerance reduction to enhance coupling quality.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A prefabricated canvas frame for fitting canvas to display the canvas, comprising:
a square prefabricated frame adapted to detachably fit the canvas thereto; and
a stripe member disposed on the prefabricated frame to support the canvas thereagainst,
wherein the prefabricated frame comprises corner members located at four corner portions of the canvas and edge members for connecting the corner members to allow the prefabricated frame to have the shape of square, the corner members and the edge members having a shape of a hollow tube, and the stripe member comprises corner stripes located along the corner members and edge stripes located along the edge members, each corner stripe being formed unitarily with each corner member and each edge stripe being formed unitarily with each edge member, each edge stripe having a higher height by a wall surface thickness of each corner member than each corner stripe so that when the edge member is fitted to the corner member, top of the edge stripe and top of the corner stripe of the corner member are arranged on the same line as each other.

2. The prefabricated canvas frame according to claim 1, wherein after the edge member is fitted to the corner member, the corner stripe of the corner member is bonded to the edge stripe of the edge member.

3. The prefabricated canvas frame according to claim 1, wherein the edge member further has a plurality of cut-off lines spaced apart from each other by a given distance, so that the edge member is cut off by the given distance.

4. A prefabricated canvas frame for fitting canvas to display the canvas, comprising:
a square prefabricated frame adapted to detachably fit the canvas thereto; and
a stripe member disposed on the prefabricated frame to support the canvas thereagainst,
wherein the prefabricated frame comprises corner members located at four corner portions of the canvas and edge members for connecting the corner members to allow the prefabricated frame to have the generally square shape, the corner members and the edge members having a shape of a hollow tube, and the stripe member comprises corner stripes located along the corner members and edge stripes located along the edge members, each corner stripe being formed unitarily with each corner member and each edge stripe being formed unitarily with each edge member, and each corner member having a corner open portion open from an inner side thereof to a corner thereof so that when the edge member is inserted into the inside of the corner member, the edge stripe is exposed to the outside through the corner open portion.

5. The prefabricated canvas frame according to claim 4, wherein each edge stripe is extended outwardly from the edge of the edge member to have the same plane as a side surface adjacent thereto.

6. The prefabricated canvas frame according to claim 4, wherein the side surface adjacent to the edge member is a side surface corresponding to a short side, and the edge member and the corner member have a cross section of a rectangular parallelepiped.

7. The prefabricated canvas frame according to claim 4, wherein each corner stripe is extended outwardly from the end portion of the edge of the corner open portion to have the same plane as a side surface adjacent thereto and is laminated on the edge stripe exposed to the outside through the corner open portion.

8. The prefabricated canvas frame according to claim 4, wherein the corner member has a corner reinforcement member having a plane section of a right triangle in such a manner as to connect both side surfaces perpendicular to each other toward the inside thereof.
